(19) United States
(12) Patent Application Publication
(10) Pub. No.: US 2013/0188811 A1
(43) Pub. Date: Jul. 25, 2013

(54) METHOD OF CONTROLLING SOUNDS GENERATED IN A HEARING AID AND A HEARING AID

(71) Applicant: Widex A/S, Lynge (DK)

(72) Inventor: Thilo Volker THIEDE, Kobenhavn O (DK)

(73) Assignee: WIDEX A/S, Lynge (DK)

(21) Appl. No.: 13/796,780

(22) Filed: Mar. 12, 2013

Related U.S. Application Data
(63) Continuation-in-part of application No. PCT/EP2010/067923, filed on Nov. 22, 2010.

(51) Int. Cl. H04R 25/00

(52) U.S. Cl. CPC H04R 25/50
USPC 381/312

(57) ABSTRACT

A hearing aid (100) configured to control the generation of relaxing sound comprises an acoustical-electrical transducer (101), means (105) for deriving a characteristic value from the electrical audio signal, comparator means (106) configured to compare the derived characteristic value with a selected threshold value; relaxing sound generating means (108), first signal processing means (109) adapted for increasing or decreasing the level of the electrical relaxing sound signal as a function of the control value and a selected threshold value, means (102) for adding the processed electrical relaxing sound signal to the electrical audio signal, second signal processing means (103) configured to amplify the electrical input signal and an electrical-acoustical output transducer (104). The invention further provides a method of controlling the generation of relaxing sound in a hearing aid (100).

### RELATED APPLICATIONS

The present application is a continuation-in-part of application PCT/EP2010/067923, filed on Nov. 22, 2010, in Europe, and published as WO2012069074 A1.

### BACKGROUND OF THE INVENTION

1. Field of the Invention

The present invention relates to hearing aids. The invention more specifically relates to hearing aids, configured to internally generate sounds. The invention also relates to a method for controlling the internal generation of sounds in a hearing aid.

In the context of the present disclosure, a hearing aid should be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, resulting in a so-called audiogram, of the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor, and an acoustic output transducer. The signal processor is preferably a digital signal processor. The hearing aid is enclosed in a casing suitable for fitting behind or in a human ear.

As the name suggests, Behind-The-Ear (BTE) hearing aids are worn behind the ear. To be more precise an electronics unit comprising a housing containing the major electronics parts thereof is worn behind the ear. An earpiece for emitting sound to the hearing aid user is worn in the ear, e.g. in the concha or the ear canal. In a traditional BTE hearing aid, a sound tube is used because the output transducer, which in hearing aid terminology is normally referred to as the receiver, is located in the housing of the electronics unit. In some modern types of hearing aids a conducting member comprising electrical conductors is used, because the receiver is placed in the earpiece in the ear. Such hearing aids are commonly referred to as Receiver-In-The-Ear (RITE) hearing aids. In a specific type of RITE hearing aids the receiver is placed inside the ear canal. This type is known as Receiver-In-Canal (RIC) hearing aids.

In-The-Ear (ITE) hearing aids are designed for arrangement in the ear, normally in the funnel-shaped outer part of the ear canal. In a specific type of ITE hearing aids the hearing aid is placed substantially inside the ear canal. This type is known as Completely-In-Canal (CIC) hearing aids. This type of hearing aid requires a very compact design in order to allow it to be arranged in the ear canal, while accommodating the components necessary for operation of the hearing aid, such as microphones, a battery, a microelectronic circuit comprising a signal processor, and an acoustic output transducer.

Internally generated sounds are used for providing information to the user and for comfort, be it for masking undesired sounds or just for causing a relaxing experience.

In the context of the present disclosure, a relaxing sound should be understood as a sound having a quality whereby it is easy to relax and be relieved of e.g. stress and anxiety when subjected to it. Traditional music is one example of relaxing sound while noise is most often used to refer to a sound that is not relaxing.

2. The Prior Art

U.S. Pat. No. B2-6,816,599 discloses one type of relaxing sound, that can be generated by a music synthesizer in a way that is very well suited for implementation in e.g. a hearing aid.

U.S. Pat. No. 6,047,074 discloses a hearing aid that can also be utilized for tinnitus therapy, wherein a useful digital signal, derived from the output signal from the hearing aid input transducer, can be evaluated in terms of its intensity, its spectral distribution and/or its time structure such that an oppositely directed (compensating) behavior can be achieved. Hereby the signals for tinnitus therapy can be activated only when no useful signal is present. Arbitrary transition times between end of the useful signal and beginning of the signals for tinnitus therapy can thereby be set. When a longer quiet pause occurs, then the masking signal is slowly mixed in and thus drowns out the disturbing tinnitus noise. It is also disclosed that melodic sound sequences or other tones can be used to mask the tinnitus

One problem with prior art hearing aid systems configured to generate relaxing sounds is that the methods used to control the relaxing sounds are too simple to provide satisfactory performance for the hearing aid user. This is especially the case if the hearing aid user desires to use the relaxing sounds in order to draw the hearing aid user's attention away from e.g. a perceived tinnitus tone. In this case, it is important that the hearing aid user does not consciously perceive when the level of the relaxing sounds are increased or decreased.

It is therefore a feature of the present invention to provide a hearing aid system with improved means for controlling the generation of relaxing sound.

It is another feature of the present invention to provide an improved method for controlling the generation of relaxing sound.

### SUMMARY OF THE INVENTION

The invention, in a first aspect, provides a hearing aid configured to control the generation of relaxing sound comprising: an acoustical-electrical transducer adapted for converting an acoustical input sound into an electrical audio signal; means for deriving a characteristic value from the electrical audio signal; comparator means configured to compare the derived characteristic value with a selected threshold value hereby providing a control value; switching means configured to select a first threshold value if the characteristic value drops below a second threshold value, while the second threshold value is selected, and to select the second threshold value if the characteristic value exceeds the first threshold value, while the first threshold value is selected, and wherein the second threshold value is smaller than the first threshold value; relaxing sound generating means for providing an electrical relaxing sound signal; first signal processing means adapted for increasing or decreasing the level of the electrical relaxing sound signal as a function of the control value and the selected threshold value, hereby providing a processed electrical relaxing sound signal; means for adding the processed electrical relaxing sound signal to the electrical audio signal hereby providing an electrical input signal; second signal processing means configured to amplify the electrical input signal in order to alleviate a hearing loss of a hearing aid user, hereby providing an electrical output signal; and an electrical-acoustical output transducer for converting the electrical output signal into sound.

This provides a hearing aid with improved means for controlling the generation of relaxing sound.

The invention, in a second aspect, provides a method of controlling the generation of relaxing sound in a hearing aid, comprising the steps of: converting an acoustical input sound into an electrical audio signal; deriving a first characteristic value from the electrical audio signal; deriving a second characteristic value from the electrical audio signal; determining a level of an electrical relaxing sound signal based on the first characteristic value and the second characteristic value; and providing the acoustical relaxing sound with the determined level.

This provides an improved method for controlling the generation of relaxing sound.

Further advantageous features appear from the dependent claims.

Still other features of the present invention will become apparent to those skilled in the art from the following description wherein the invention will be explained in greater detail.

### BRIEF DESCRIPTION OF THE DRAWINGS

By way of example, there is shown and described a preferred embodiment of this invention. As will be realized, the invention is capable of other embodiments, and its several details are capable of modification in various, obvious aspects all without departing from the invention. Accordingly, the drawing and descriptions will be regarded as illustrative in nature and not as restrictive. In the drawing:

FIG. 1 illustrates highly schematically a hearing aid according to an embodiment of the invention.

### DETAILED DESCRIPTION

In the present context the term relaxing sound represents sound that is generated synthetically in a hearing aid in order to help people concentrate and to make people feel more relaxed and comfortable, and to reduce stress and to make people feel less anxious.

In one aspect the relaxing sound can help to achieve this by masking unwanted and disturbing sounds. In another aspect it has been found that the relaxing sound can by itself help to achieve this independent on whether the surroundings are quiet or relatively noisy.

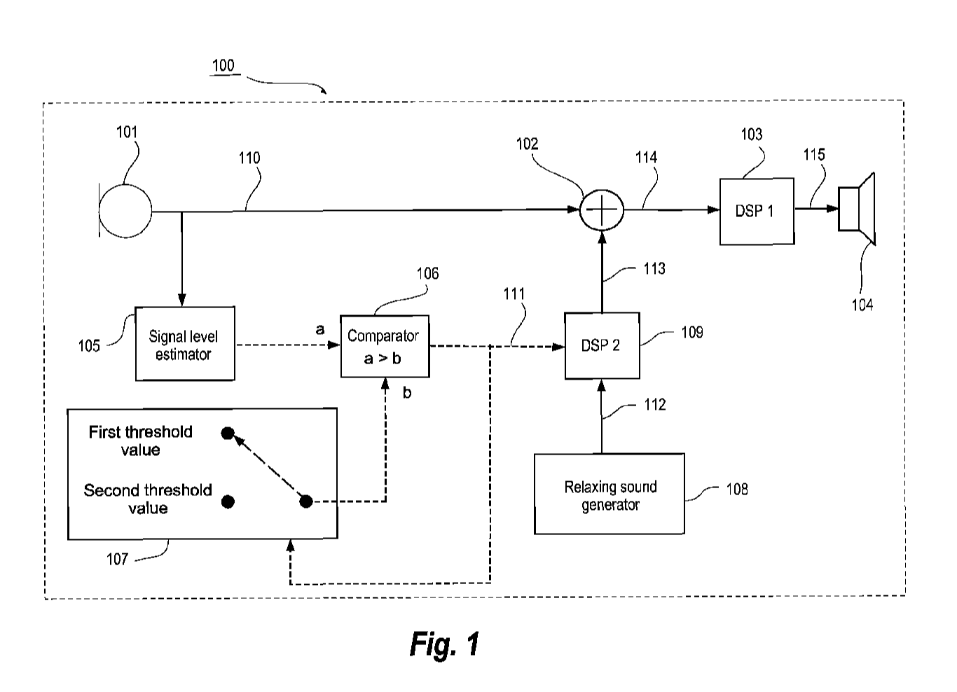

Reference is now made to FIG. 1, which illustrates highly schematically a hearing aid 100 according to an embodiment of the invention. The hearing aid 100 comprises an acoustical-electrical transducer 101, a summing unit 102, a first digital signal processor (DSP 1) 103, an electrical-acoustical transducer 104, a signal level estimator 105, comparator means 106, switching means 107, a sound generator 108 and a second digital signal processor (DSP 2) 109.

According to a variation of the embodiment of FIG. 1 two or more of the digital processing units 102, 103, 105, 106, 107, 108 and 109 may be integrated in a signal digital signal processor.

The acoustical-electrical transducer 101 transforms an acoustic signal from the surroundings into an electrical audio signal 110, which is provided to a first input of the summing unit 102 and to the signal level estimator 105. The estimate of the level of the electrical audio signal 110 is used as a first input value to the comparator means 106, while the second input value to the comparator means 106 is provided by the switching means 107, that provides either a first or a second threshold value wherein the value of the first threshold value is larger than the value of the second threshold value. The comparator means 106 evaluates which of the two input values are larger, and the comparator output signal 111 represents the result of this evaluation. In addition the comparator output signal 111 comprises information of the selected threshold value. The comparator output signal 111 is provided to a first input of the second signal processor 109 and the comparator output signal is used to control the second signal processor 109.

The switching means 107 is configured to replace the first threshold value with the second threshold value when the estimate of the electrical audio signal level exceeds the first threshold value, and to replace the second threshold value with the first threshold value when the estimate of the electrical audio signal level drops below the second threshold value. Hereby hysteresis is introduced into the decision process and it is avoided that the value of the comparator output signal 111 changes too often.

The sound generator 108 provides an electrical signal representing unprocessed relaxing sound 112, or just the electrical relaxing sound signal 112, to a second input of the second signal processor 109. The signal processor 109 provides an electrical signal representing processed relaxing sound 113.

In a first state the signal processor 109 provides an electrical signal 113 that is muted in response to a situation where the estimate of the level of the electrical audio signal level is larger than the selected threshold value, and the second threshold is selected in the switching means 107.

In a second state the signal processor 109 provides an electrical signal 113 that is identical to the electrical signal representing unprocessed relaxing sound 112 in response to a situation where the estimate of the level of the electrical audio signal level is smaller than the selected threshold value, and the first threshold is selected in the switching means 107.

The signal representing processed relaxing sound 113 is provided to a second input of the summing unit 102, whereby the summing unit 102 provides a sum signal 114 that is the sum of the processed relaxing sound signal 113 and the electrical audio signal 110.

The sum signal 114 is provided to an input of the first signal processor 103 for further standard hearing aid signal processing adapted for alleviating a hearing deficit of the hearing aid user. Finally the signal processor 103 provides an electrical output signal 115 to the electrical-acoustical transducer 104 for converting the electrical output signal 115 into sound.

According to the embodiment of FIG. 1 the first threshold level is 30 dB Sound Pressure Level (SPL) and the second threshold level is 25 dB SPL, i.e. the difference between the first and second threshold levels is 5 dB SPL. In variations of the embodiment of FIG. 1 the difference is in the range between 3 and 8 dB SPL.

In variations of the embodiment of FIG. 1 the first threshold level is in the range between 10 and 60 dB SPL. In further variations the first threshold level is in the range between 10 and 30 dB SPL or in the range between 30 and 60 dB SPL.

Low threshold levels are attractive for hearing aid users that primarily need the relaxing sound in quiet surroundings, e.g. for drawing the attention of the hearing aid user away from a perceived tinnitus tone.

High threshold levels may especially be attractive for hearing aid users that also would like to listen to the relaxing sounds in normal sound environments in order to e.g. relieve stress or enhance the ability to mentally focus. According to a further variation of the embodiment of FIG. 1 related to this type of hearing aid users the level of the relaxing sound signal may be controlled such that it corresponds to the estimate of the level of the electrical audio signal.

According to a variation of the embodiment of FIG. 1, the switching means 107, comparator means 106 and second signal processor 109 are adapted to gradually attenuate the signal level of the relaxing sound signal 113 as a function of an increasing value of the estimate of the electrical audio signal level. This can be achieved by providing a set of first threshold values and a set of second threshold values wherein each set define a set of consecutive ranges. First and second threshold values are formed in pairs in accordance with the embodiment described above wherein the value of the second threshold value is smaller than the first threshold value. The above described range is defined by having an upper limit defined by a first threshold value from a first pair of threshold values and a lower limit defined by a second threshold value from a second pair of threshold values, wherein the second pair of threshold values is smaller than the first pair of threshold values. Each range corresponds to an attenuation value whereby the signal level of the relaxing sound signal can be attenuated dependent on the specific range that includes the current estimate of the electrical audio signal level.

According to another variation of the embodiment of FIG. 1 a speech detector (not shown) provides an additional control input signal to the second signal processor 109, whereby the acoustical relaxing sound signal is muted independently of the estimated signal level. The speech detector can be implemented using a great variety of algorithms. One such algorithm simply considers the modulation of the electrical audio signal; because high signal modulation is characteristic for speech, see e.g. U.S. Pat. No. B2-6,735,317, page 6, line 22-56.

According to further variations of the embodiment of FIG. 1, the speech detector provides an additional input signal to the second signal processor 109, whereby the acoustical relaxing sound signal is muted independently of the estimated signal level, and wherein the comparator output signal 111 that constitutes the original control input signal to the second signal processor 109 is the result of a comparison that does not include the hysteresis aspect.

According to further variations of the embodiment of FIG. 1 the acoustical relaxing sound signal is muted in different ways dependent on the circumstances.

According to one variation the muting is instantaneous, if speech is detected, in the sense that the processed relaxing sound signal 113 is simply set to zero by the second signal processor 109 in response to the positive speech detection. Such a muting will typically be perceived as audible by the hearing aid user due to the abrupt nature of the muting. According to a further variation the muting is set to zero in less than 100 microseconds. In yet a further variation the level of the relaxing sound is gradually decreased to zero during a time span of less than 500 milliseconds, preferably in the range of 1 to 20 milliseconds.

According to another variation the acoustical relaxing sound signal consists of a consecutive sequence of tones with varying characteristics such as e.g. frequency, distortion, amplitude and duration. For such types of internally generated relaxing sound the relaxing sound generator 108 can stop the generation of new tones while existing tones are allowed to slowly fade-out, whereby the muting of the relaxing sound will not be perceived by most users. According to a specific variation the existing tones will hereby fade-out within a range of 0.5 and 5 seconds, preferably within 1 and 2 seconds. An algorithm, for providing this type of relaxing sound, which lends itself very well to implementation in a hearing aid, is disclosed in e.g. U.S. Pat. No. B2-6,816,599, column 8, line 14 to column 11, line 16.

1. A hearing aid configured to control the generation of relaxing sound comprising:
an acoustical-electrical transducer adapted for converting an acoustical input sound into an electrical audio signal;
means for deriving a characteristic value from the electrical audio signal;
comparator means configured to compare the derived characteristic value with a selected threshold value hereby providing a control value;
switching means configured to select a first threshold value if the characteristic value drops below a second threshold value, while the second threshold value is selected, and to select the second threshold value if the characteristic value exceeds the first threshold value, while the first threshold value is selected, and wherein the second threshold value is smaller than the first threshold value;
relaxing sound generating means for providing an electrical relaxing sound signal;
first signal processing means adapted for increasing or decreasing the level of the electrical relaxing sound signal as a function of the control value and the selected threshold value, hereby providing a processed electrical relaxing sound signal;
means for adding the processed electrical relaxing sound signal to the electrical audio signal hereby providing an electrical input signal;
second signal processing means configured to amplify the electrical input signal in order to alleviate a hearing loss of a hearing aid user, hereby providing an electrical output signal; and
an electrical-acoustical output transducer for converting the electrical output signal into sound.

2. The hearing aid according to claim 1, wherein the means for deriving a characteristic value estimates the sound pressure level of the acoustical input sound.

3. The hearing aid according to claim 1, comprising means for detecting speech in the electrical audio signal and wherein the second signal processing means or the relaxing sound generating means are configured to mute the acoustical relaxing sound if speech is detected.

4. The hearing aid according to claim 1, wherein the relaxing sound generating means comprise means for providing an electrical relaxing sound signal representing a consecutive set of tones with varying tonal characteristics.

5. The hearing aid according to claim 4, wherein the relaxing sound generating means are configured to discontinue the generation of new tones while already generated tones are allowed to fade-out in response to a situation where the first characteristic value exceeds the first threshold value, while the first threshold value is selected.

6. A method of controlling the generation of relaxing sound in a hearing aid, comprising the steps of:
converting an acoustical input sound into an electrical audio signal;
deriving a first characteristic value from the electrical audio signal;
deriving a second characteristic value from the electrical audio signal;
determining a level of an electrical relaxing sound signal based on the first characteristic value and the second characteristic value; and
providing the acoustical relaxing sound with the determined level.

7. The method according to claim 6, comprising the steps of:
providing a first threshold value;
providing a second threshold value, wherein the second threshold value is smaller than the first threshold value;
deriving the first characteristic value at a first point in time;
deriving the second characteristic value at a second point in time, wherein the second point in time is later than the first point in time;
selecting the first threshold value if the first characteristic value drops below the second threshold value;
selecting the second threshold value if the first characteristic value exceeds the first threshold value;
decreasing the level of the electrical relaxing sound signal if the second characteristic value is greater than the first threshold value and the first threshold value is selected;
increasing the level of the electrical relaxing sound signal if the second characteristic value is smaller than the second threshold value and the second threshold value is selected.

8. The method according to claim 7, comprising the step of:
muting the acoustical relaxing sound in response to a positive value of a third characteristic value, wherein the third characteristic value is positive if speech is detected in the electrical audio signal, and negative if speech is not detected in the electrical audio signal.

9. The method according to claim 6, wherein the first characteristic value and the second characteristic value are estimates of the input sound pressure level.

10. The method according to claim 9, wherein the difference between the first threshold value and the second threshold value is in the range between 3 and 8 decibel SPL.

11. The method according to claim 9, wherein the first threshold value corresponds to an estimated input sound pressure level that is in the range between 10 and 60 decibel SPL.

12. The method according to claim 7, wherein the acoustical relaxing sound is muted if the first characteristic value exceeds the first threshold value.

13. The method according to claim 12, wherein the muting of the acoustical relaxing sound is carried out by discontinuing the generation of new relaxing tones whereby the muting becomes more difficult to consciously perceive for a user of the hearing aid.

14. The method according to claim 13, wherein existing relaxing tones will fade out during a time span in the range between 0.5 and 5 seconds after the generation of new relaxing tones has been discontinued.

15. The method according to claim 6, comprising the steps of:
determining the level of the electrical relaxing sound signal to correspond to the estimate of the input sound pressure level;
muting the acoustical relaxing sound in response to a positive value of the second characteristic value, wherein the second characteristic value is positive if speech is detected in the electrical audio signal and negative if speech is not detected in the electrical audio signal.

16. The method according to claim 6, comprising the steps of:
determining the level of the electrical relaxing sound signal to be oppositely directed with respect to the estimate of the input sound pressure level;
muting the acoustical relaxing sound in response to a positive value of the second characteristic value, wherein the second characteristic value is positive if speech is detected in the electrical audio signal and negative if speech is not detected in the electrical audio signal.

17. The method according to claim 8, wherein the acoustical relaxing sound is muted less than 100 microseconds after speech has been detected.

18. The method according to claim 8, wherein the level of the acoustical relaxing sound is gradually decreased to zero in a time span in the range between 1 and 20 milliseconds after speech has been detected.
